(19) United States
(12) Patent Application Publication
(10) Pub. No.: US 2007/0058049 A1
(43) Pub. Date: Mar. 15, 2007

(54) IMAGE SENSING APPARATUS AND METHOD OF CONTROLLING THE SAME

(76) Inventor: Hideo KAWAHARA, Hatogaya-shi (JP)

Correspondence Address: MORGAN & FINNEGAN, L.L.P., 3 WORLD FINANCIAL CENTER, NEW YORK, NY, 10281-2101, US

(21) Appl. No.: 11/470,743

(22) Filed: Sep. 7, 2006

(30) Foreign Application Priority Data
Sep. 9, 2005 (JP) 2005-262977

(51) Int. Cl. H04N 5/225

(52) U.S. Cl. 348/218.1

(57) ABSTRACT

Disclosed is a method of controlling an image sensing apparatus for sensing a plurality of images at exposure period shorter than one vertical scanning period every vertical scanning period of a moving image, superimposing and synthesizing the plurality of images while shifting them relative to one another so as to cancel out shaking of the image sensing apparatus, and outputting a single synthesized image every vertical scanning period. A plurality of images are sensed with exposure period shorter than the one vertical scanning period, and focus control is performed based upon a sensed image.

### BACKGROUND OF THE INVENTION

1. Field of the Invention

The present invention relates to an image sensing apparatus and method of controlling this apparatus. More particularly, the invention relates to a technique for controlling focusing in an image sensing apparatus that is capable of sensing moving images.

2. Description of the Related Art

Image sensing apparatuses have been reduced in size and provided with optical systems of higher magnification in recent years. This has been accompanied by the problem of diminished image quality of captured images owing to shaking of the apparatus. A variety of shake compensating functions, which compensate for image blurring caused by shaking (shaking of the hand) of the image sensing apparatus, have been proposed as measures for solving this problem. By equipping an image sensing apparatus with a shake compensating function, it has become possible to readily sense excellent images with little blurring.

The following methods have been proposed as shake compensating functions installed in a video camera: a so-called optical shake compensating method (e.g., see the specification of Japanese Patent Application Laid-Open No. 9-181959) that compensates for shaking optically, and an electronic shake compensating method (e.g., see the specification of Japanese Patent Application Laid-Open No. 10-178582) that compensates for shaking by electrical processing.

With the optical shake compensating method, the angular displacement of a camera is obtained as by using an angular velocity sensor or by detecting the motion vector of a screen by processing a plurality of sensed images, and shaking is cancelled out by displacing the optical axis optically based upon the angular displacement obtained. For example, the optic axis of light incident upon an image sensing element is displaced by displacing a shake compensating lens in a plane orthogonal to the optic axis. By thus optically canceling shaking of a video camera, optical shake compensation is performed and a blur-free moving image can be sensed. With the optical shake compensating method, however, mechanical members such as actuators and optical elements are required. This limits camera size reduction and is disadvantageous in terms of cost.

According to the electronic shake compensation method, use is made of an image sensing element larger than the image size actually required, and recording is performed sequentially while a part of the obtained image is cut from the obtained image so as to compensate for shaking of the camera in accordance with the angle of displacement of the camera, thereby implementing the sensing of a blur-free moving image. FIGS. 7A to 7C are diagrams illustrating the concept of this operation, in which FIG. 7A illustrates an image obtained in a certain vertical scanning period, FIG. 7B an image obtained in the next vertical scanning period and FIG. 7C an image actually displayed upon cutting out parts of the images of FIG. 7A and 7B updated every vertical scanning period. With the electronic shake compensation method, mechanical members such as actuators and optical sensing elements needed in the optical shake compensation method are unnecessary. This is advantageous in terms of camera size reduction and cost and therefore this method is in wide use. However, the electronic shake compensation method cannot compensate for shaking that occurs in one vertical scanning period (i.e., during charge accumulation period) and hence there is a limit upon shake compensation accuracy.

Further, the following method is described in the specification of, e.g., Japanese Patent Application Laid-Open No. 11-25255 as a method of electronic shake compensation applied to still images: First, a plurality of images are sensed by a high-speed electronic shutter at the time of photography, and amount of hand-induced shaking is detected by vector detection. Then, based upon the amount of hand-induced shaking detected, the cut-out positions of the plurality of sensed images are changed so as to compensate for hand-induced shaking and the plurality of cut-out images are superimposed and synthesized into one still image. This method provides a shake compensating effect and makes it possible to obtain a still image having a sufficient amount of exposure.

The still-image electronic shake compensation processing for sensing a plurality of images by the high-speed shutter and synthesizing the images is performed every vertical scanning period when a moving image is sensed, thereby making it possible to compensate for shaking within one vertical scanning period of the moving image.

Camera systems such as a conventional video cameras capable of sensing moving images have been automated and provided with multiple functions, as seen in functions such as automatic exposure (AE) and autofocus (AF), etc., and excellent movies can be sensed.

However, in the method of compensating for shaking within one vertical scanning period of a moving image by executing processing for sensing a plurality of images and synthesizing them every vertical scanning period, there are no proposals regarding how to perform AF control.

For example, if AF control is carried out based upon sensed images in each vertical scanning period, as in the conventional method of sensing moving images, a certain problem arises. Specifically, since the image in each vertical scanning period is obtained only after synthesizing images following the end of sensing a plurality of images every vertical scanning period, the time required until AF control can begin is prolonged in comparison with the prior art and the accuracy of AF control declines.

### SUMMARY OF THE INVENTION

The present invention has been devised in consideration of the foregoing circumstances and its object is to provide an image sensing apparatus and method of controlling the same whereby it is possible to compensate for shaking of an image in each vertical scanning period, output compensated images successively at the vertical scanning period and perform more accurate autofocus control.

According to the present invention, the foregoing object is attained by providing an image sensing apparatus comprising:

a processing unit that superimposes and synthesizes a plurality of images obtained by sensing with exposure period shorter than one vertical scanning period every vertical scanning period of a moving image while shifting them relative to one another so as to cancel out shaking of the image sensing apparatus, and outputting a single synthesized image every vertical scanning period;

a focus lens; and

a focus control unit that performs focus control by driving the focus lens based upon a sensed image in response to sensing of the plurality of images performed in each of the vertical scanning periods.

According to the present invention, the foregoing object is also attained by providing a method of controlling an image sensing apparatus for sensing a plurality of images with exposure period shorter than one vertical scanning period every vertical scanning period of a moving image, the method comprising:

a processing step of superimposing and synthesizing the plurality of images while shifting them relative to one another so as to cancel out shaking of the image sensing apparatus, and outputting a single synthesized image every vertical scanning period;

a sensing step of sensing images at exposure times shorter than the one vertical scanning period; and

a focus control step of performing focus control based upon images obtained by sensing at the image sensing step.

Further features of the present invention will become apparent from the following description of exemplary embodiments with reference to attached drawings.

### BRIEF DESCRIPTION OF THE DRAWINGS

FIG. 1 is a block diagram illustrating a brief configuration of a camera system according to a first embodiment of the present invention;

FIG. 2 is a timing chart illustrating timing of image sensing processing according to the first embodiment of the camera system shown in FIG. 1;

FIG. 3 is a diagram useful in describing coordinate transformation and synthesizing processing;

FIG. 4 is a flowchart for describing an operation of autofocus control;

FIG. 5 is a block diagram illustrating a brief configuration of a camera system in a modification of the present invention;

FIG. 6 is a timing chart illustrating timing of image sensing processing in a camera system according to a second embodiment of the present invention; and

FIGS. 7A to 7C are diagrams useful in describing processing for compensating for shaking of a moving image according to the prior art.

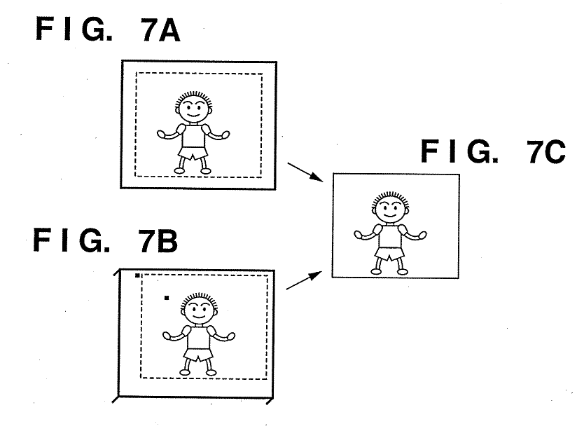

### DESCRIPTION OF THE EMBODIMENTS

### First Embodiment

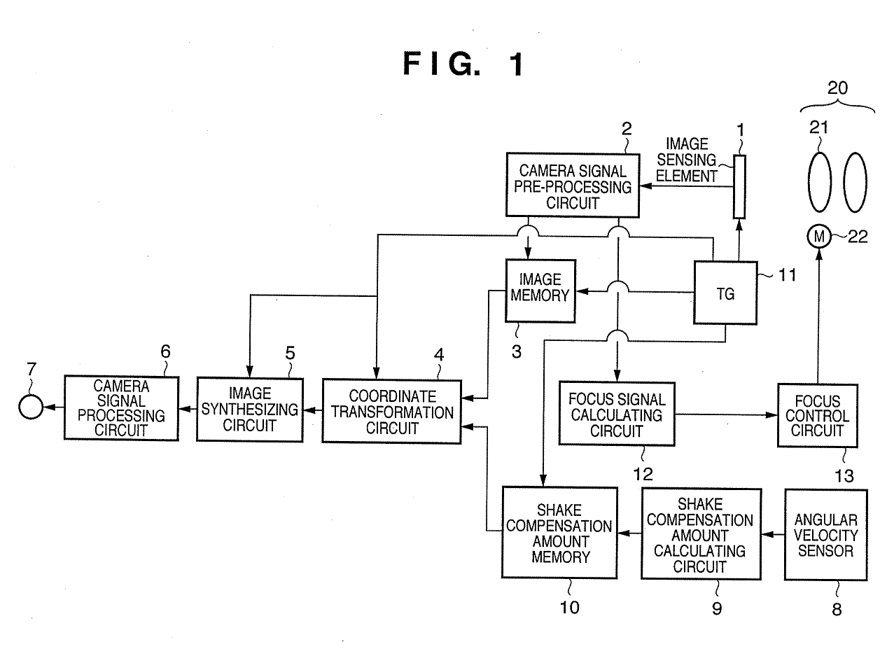

FIG. 1 is a block diagram illustrating a brief configuration of a camera system, which is capable of sensing a moving image, as an image sensing apparatus according to a first embodiment of the present invention.

As shown in FIG. 1, a lens unit 20, which constitutes part of an optical system, is capable of being removably attached to a camera body of the camera system. The lens unit 20 is obtained by combining a plurality of lenses that include a focus lens 21. By changing the position of the focus lens 21 using a focus drive motor 22, focus control can be carried out. It should be noted that the lens unit 20 may be integrally formed on the camera body as a matter of course.

An image sensing element 1, which is typified by a CCD sensor or CMOS sensor, photoelectronically converts an incident optical image of a subject and outputs an electric signal. A camera signal pre-processing circuit 2 subjects the electric signal, which is output from the image sensing element 1, to prescribed signal processing such as processing for generating a luminance signal and color signal to their effect a conversion to an image signal (image data). An image memory 3 stores the image signal that is output from the camera signal pre-processing circuit 2. A coordinate transformation circuit 4 transforms the two-dimensional coordinates of an image signal, which has been read out of the image memory 3, in accordance with the amount of shake compensation (described later) of the camera system. An image synthesizing circuit 5 synthesizes image signals, which have been obtained at mutually different timings, obtained by the coordinate transformation in the coordinate transformation circuit 4. As will be described later, shake compensation of each image obtained every vertical scanning period can be implemented by the coordinate transformation circuit 4 and image synthesizing circuit 5.

A camera signal processing circuit 6 converts the image signal, which has been synthesized by the image synthesizing circuit 5, to a well-known standard video signal typified by an NTSC signal, by way of example. The standard video signal obtained by the conversion in the camera signal processing circuit 6 is output as a moving image at a prescribed vertical scanning period, e.g., every 1/60 of a second, via a video output terminal 7.

Further components of the shake compensation mechanism possessed by the camera system are an angular velocity sensor 8 (e.g., a vibration gyro may be used), which is provided on the casing of the camera system, for detecting amount of shaking of the camera system, the angular velocity sensor 8 outputting a signal (information indicative of angular velocity, referred to as an “angular velocity signal” below), which represents shaking of the camera system as angular velocity, in conformity with the timing at which electric charge is read out of the image sensing element 1; a shake compensation amount calculating circuit 9 for calculating amount of shake compensation based upon the angular velocity signal that is output from the angular velocity sensor 8; and a shake compensation amount memory 10 for storing amount of shake compensation calculated by the shake compensation amount calculating circuit 9. Amounts of shake compensation that are output from the shake compensation amount calculating circuit 9 are stored sequentially in the shake compensation amount memory 10, based upon a prescribed timing signal generated by a timing generator (TG) 11, in association with image signals that have been read out of the image sensing element 1.

The timing generator 11 generates a reference signal that serves as the basis of operation timing of the camera system. The timing generator 11 supplies the image sensing element 1, image memory 3, coordinate transformation circuit 4, image synthesizing circuit 5 and shake compensation amount memory 10 with synchronizing signals and driving signals that trigger the start of operation.

A focus signal calculating circuit 12 calculates a focus signal used in focus control based upon the image signal that is output from the camera signal pre-processing circuit 2. By way of example, the focus signal calculating circuit 12 extracts, by filtering, a specific high-frequency component contained in the image signal, obtains the amplitude thereof and outputs it as a focus signal. On the basis of a temporal change in the amplitude level of the focus signal obtained by the focus signal calculating circuit 12, a focus control circuit 13 moves the focus lens 21 via the focus drive motor 22 in a direction in which the amplitude level of the focus signal increases. An autofocus (AF) operation is performed as a result. It should be noted that the AF control method implemented by the focus signal calculating circuit 12 and focus control circuit 13 is not limited to that described above and that it is possible to use a well-known method.

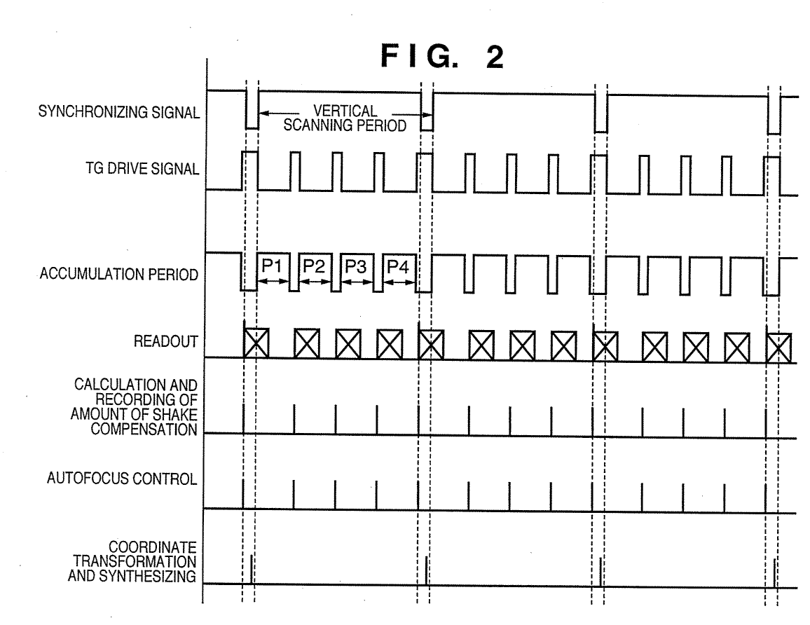

Next, reference will be had to the timing chart of FIG. 2 to describe image sensing processing of the first embodiment in the camera system having the configuration set forth above. The first embodiment will be described with regard to a case where four images are sensed every vertical scanning period (e.g., every 1/60 of a second) and synthesized by being superimposed. In this embodiment, four images read out by the high-speed electronic shutter in one vertical scanning period shall be referred to as “high-speed images” (IM1 to IM4), and a single image in one vertical scanning period obtained by synthesizing the four high-speed images shall be referred to as a “vertical-scanning-period image”, in order distinguish these signals.

As illustrated in FIG. 2, the timing generator 11 generates four pulses every vertical scanning period as a TG drive in sync with a synchronizing signal. In accordance with the pulses, the image sensing element 1 accumulates electric charge in respective ones of four accumulation periods P1 to P4 every vertical scanning period. Whenever each of the accumulation periods P1 to P4 elapses, the image sensing element 1 outputs an electric-charge signal to the camera signal pre-processing circuit 2 at a timing indicated at “READOUT”, the above-described processing is applied and the processed image signals (i.e., the high-speed images IM1 to IM4) are stored in the image memory 3.

Further, as indicated by “CALCULATION AND RECORDING OF AMOUNT OF SHAKE COMPENSATION” in FIG. 2, the shake compensation amount calculating circuit 9 acquires the angular velocity signal from the angular velocity sensor 8 at readout-start timing of the electric signal, calculates the amount of shake compensation based upon the angular velocity signal acquired and stores the amount of compensation in the shake compensation amount memory 10.

When the high-speed images IM1 to IM4 obtained in one vertical scanning period have all been stored in the image memory 3, the coordinate transformation circuit 4 reads the high-speed images IM1 to IM4 out of the image memory 3 at a timing indicated at “COORDINATE TRANSFORMATION AND SYNTHESIZING” in FIG. 2. Furthermore, the coordinate transformation circuit 4 acquires the amount of shake compensation from the shake compensation amount memory 10 and applies a two-dimensional transformation so as to cancel out a deviation among the high-speed images IM1 to IM4. The image synthesizing circuit 5 then cuts out and adds desired areas from the high-speed images IM1 to IM4 obtained by the coordinate transformation, thereby executing image synthesizing processing, and outputs the vertical-scanning-period image.

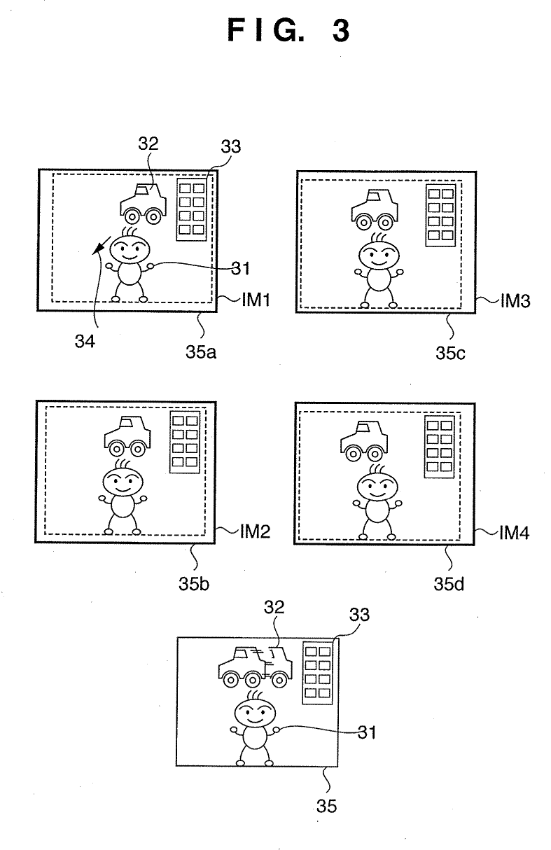

Reference will now be had to FIG. 3 to describe the two-dimensional transformation and image synthesizing processing set forth above.

In FIG. 3, IM1 to IM4 schematically represent a plurality of high-speed images that have been sensed at equal time intervals in any one vertical scanning period, as indicated by the accumulation periods P1 to P4 in FIG. 2, by way of example. Each high-speed image is indicative of the full pixel data of image sensing element 1. In FIG. 3, a main subject 31 is a person, a subject 32 is mobile, such as a vehicle, and a building is indicated at 33. An arrow 34 indicates direction of movement of the image caused by rotational shaking of the image sensing apparatus. In other words, hand-induced shaking in the direction of arrow 34 is occurring during acquisition of the high-speed images IM1 to IM4.

A signal indicative of the direction of shaking of the camera system, i.e., the direction of arrow 34, is obtained as the above-mentioned angular velocity signal. Accordingly, by translating the coordinates of the high-speed images IM1 to IM4 based upon the amounts of shake compensation corresponding to respective ones of the high-speed images IM1 to IM4, the amount of movement (the amount of shaking) produced by shaking of the camera system is compensated for per each of the high-speed images IM1 to IM4. This makes it possible to compensate for shaking. For example, by performing the coordinate transformation in such a manner that the coordinates of zones 35a to 35d indicated by the dashed lines in each of the high-speed images IM1 to IM4 will coincide, it is possible to cancel out movement of the camera system due to shaking.

Furthermore, a vertical-scanning-period image 35 can be formed by superimposing and synthesizing the zones 35a to 35d of the high-speed images IM1 to IM4 after the compensation thereof. By thus subjecting the high-speed images IM1 to IM4 obtained in each of the vertical scanning periods to a coordinate transformation in accordance with the amounts of shaking of the high-speed images IM1 to IM4 and then superimposing and synthesizing the results, it is possible to obtain a blur-free vertical-scanning-period image in each of the vertical scanning periods.

The foregoing has been described with regard to a case where a coordinate transformation and synthesizing are carried out after the high-speed images IM1 to IM4 are all stored in the image memory 3. However, the present invention is not limited to this arrangement and it may be so arranged that whenever each of the high-speed images IM1 to IM4 is stored in the image memory 3, the coordinate transformation and synthesizing are performed successively with regard to each of the high-speed images that have been stored.

Meanwhile, the camera signal pre-processing circuit 2 outputs the processed high-speed images IM1 to IM4 to the image memory 3 and to the focus signal calculating circuit 12 as well. Whenever a high-speed image is obtained anew, the focus signal calculating circuit 12 calculates a focus signal used in focus control and sends the calculated signal to the focus control circuit 13. By controlling the focus drive motor 22 based upon this focus signal, the focus control circuit 13 drives the focus lens and performs focus control.

Thus, it is possible to exercise AF control based upon an image obtained in every vertical scanning period in a manner similar to that of conventional autofocus control. In this case, however, AF control is applied to an image that is obtained by subjecting four high-speed images to a coordinate transformation and synthesis. In comparison with AF control performed by reading out a single image every vertical scanning period, as in the prior art, the above AF control requires time up to calculation of the focus signal, which time is longer by the length of processing time needed for the coordinate transformation and synthesizing processing. As a result, autofocus accuracy declines in comparison with the prior art.

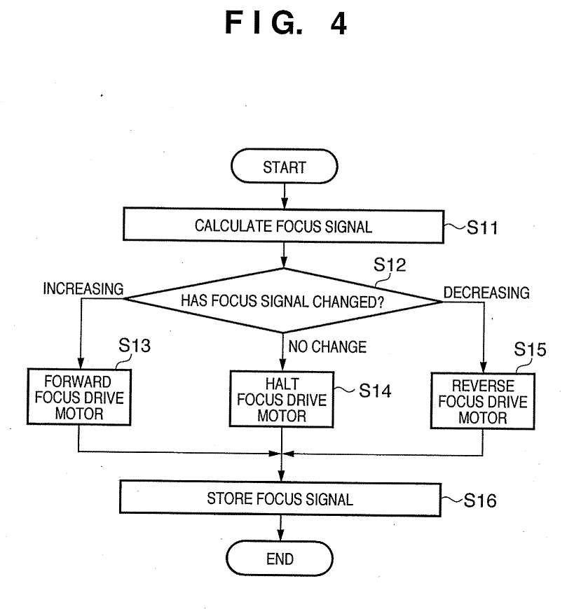

Accordingly, in the first embodiment, AF control is executed repeatedly at a timing indicated by “AUTOFOCUS CONTROL” in FIG. 2 whenever each image is captured. This AF control will be described below with reference to the flowchart of FIG. 4. The AF processing illustrated in FIG. 4 is executed by the focus signal calculating circuit 12 and focus control circuit 13.

When an image is captured and image data enters the focus signal calculating circuit 12, processing starts. At step S11 in FIG. 4, the focus signal calculating circuit 12 calculates the focus signal in the manner described above and outputs the signal to the focus control circuit 13. Next, at step S12, the focus control circuit 13 compares the focus signal found the last time by the focus signal calculating circuit 12 and the focus signal found at the time of the present processing. Control proceeds to step S13 if the focus signal is tending to increase (i.e., if the present value of the focus signal is greater than the preceding value), to step S14 if the values are the same and thus indicate no change, and to step S15 if the focus signal is tending to decrease (i.e., if the present value of the focus signal is less than the preceding value).

At step S13 it is judged that the focus lens 21 is being moved in a direction toward better focus and therefore drive by the focus drive motor 22 is continued at step S13 so as to move the focus lens 21 in the same direction. If there is no change in the focus signal, it is judged that the focus lens 21 is close to the in-focus state and therefore driving of the focus drive motor 22 is halted at step S14. At step S15, it is judged that the focus lens 21 is being moved in a direction away from the in-focus position and therefore the driving direction of the focus drive motor 22 is reversed. It should be noted that in a case where the focus signal is increased or decreased by the present cycle of AF control and the focus drive motor 22 was at rest in the preceding cycle of AF control, the set-up is such that the focus drive motor 22 is driven in either direction. Alternatively, the direction in which the focus drive motor 22 was driven the last time may be stored in advance and the motor driven in this direction. Thus the driving direction is set appropriately.

At step S16, the presently obtained focus signal and the driving direction or the at-rest state of the focus lens 21 are stored in an accessible memory such as a memory within the focus control circuit 13 in order to perform the next cycle of AF control. Processing is then exited.

It should be noted that in the first embodiment, it is described that four charge-accumulation and read-out operations are performed in one vertical scanning period in order to obtain the high-speed images. However, the number of times these operations are performed in one vertical scanning period may be at least two and is not particularly limited to four times. Further, all of the high-speed images obtained in each of the vertical scanning periods need not necessarily be synthesized, and it may be so arranged that a number of images among the high-speed images acquired are synthesized.

In accordance with the first embodiment as described above, AF control can be carried out a plurality of times in one vertical scanning period. As a result, in comparison with conventional moving-image sensing that senses one image in one vertical scanning period, it is possible to perform more accurate AF control with a higher sense of real time.

<Modification>

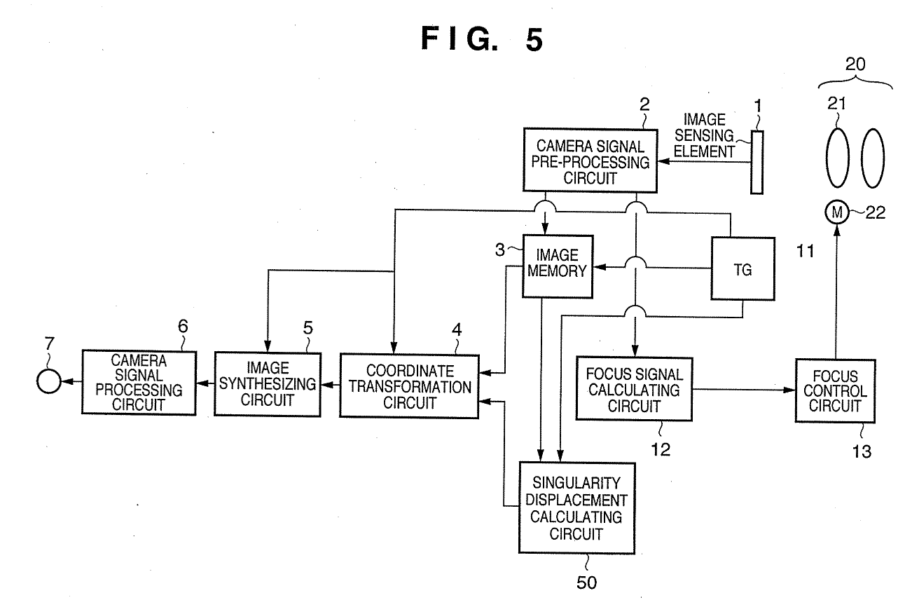

The first embodiment has been described with regard to a case where camera shake is sensed using the angular velocity sensor 8. However, it may be so arranged that by extracting singularities in images obtained from the image sensing element 1, the amount of movement between images is detected to thereby sense shaking of the camera. The general configuration of a camera system in such case is illustrated in FIG. 5. In contrast with the configuration illustrated in FIG. 1, the configuration shown in FIG. 5 is devoid of the angular velocity sensor 8, shake compensation amount calculating circuit 9 and shake compensation amount memory 10 and is instead additionally provided with a singularity displacement calculating circuit 50. Other components and operational aspects are similar to those of FIG. 1.

Operation for detecting amount of camera shake in the singularity displacement calculating circuit 50 will be described in brief with reference to FIG. 3.

The high-speed images IM1 to IM4 read out of the image memory 3 are input to the singularity displacement calculating circuit 50, which proceeds to extract a singularity. More specifically, first, from the building 33 in the high-speed image IM1, the singularity displacement calculating circuit 50 extracts the edge of a window, which is a point of high luminance, as a singularity by means of edge detection. The singularity displacement calculating circuit 50 then compares this detected singularity with a singularity obtained by detecting the edge of the window in the high-speed image IM2 that immediately follows the high-speed image IM1 and adopts the difference between the two-dimensional positions of these two singularities as the amount of shake compensation. Although the singularity is described as being a single point for the sake of explanation, in actuality a plurality of singularities can be made to exist within a single image, in which case the amounts of deviation of each of these singularities would be averaged based upon information of these singularities to obtain the amount of shake compensation. In general, the more the image of a subject contains background of little motion, the greater the number of singularities that can be extracted from the background and, hence, the greater the degree of accuracy with which movement of the image caused by hand-induced shaking can be detected.

In the description set forth above, a case where the amount of shake compensation between two high-speed images is found is described. In actuality, however, the sensing of a plurality of images to be synthesized is performed successively. Accordingly, it is possible to perform a coordinate transformation of all of the high-speed images the number of which exceeds two by accumulating differences obtained by repeating a coordinate transformation similar to that described above with regard to two high-speed images.

### Second Embodiment

A second embodiment of the present invention will now be described.

The second embodiment is characterized in that AF control is exercised intermittently and not whenever a high-speed image is output. The configuration of the camera system in the second embodiment is similar to that shown in FIG. 1 or FIG. 5 and need not be described again.

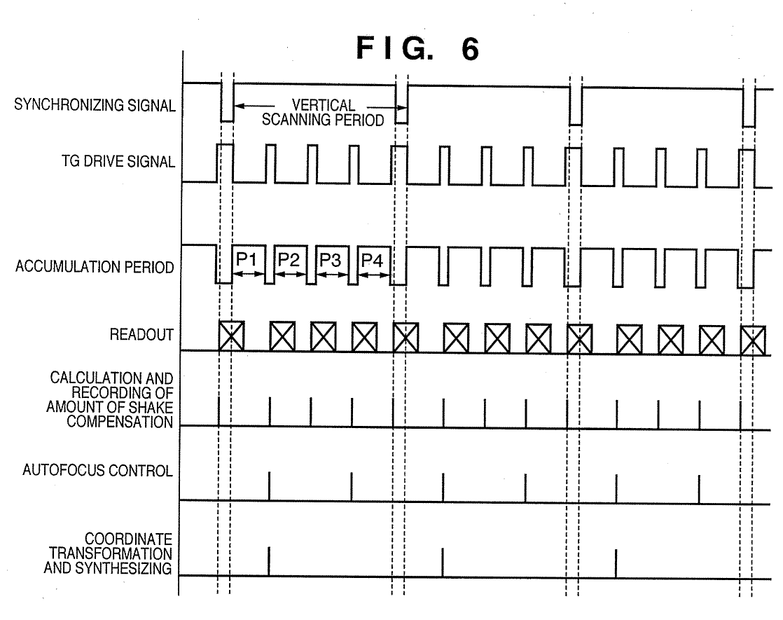

FIG. 6 is a timing chart illustrating image sensing processing according to the second embodiment. This timing chart differs from that of FIG. 2 described above in the first embodiment in that the timing of “AUTOFOCUS CONTROL” is every other charge-accumulation period. Thus, AF control is not performed at all readout timings of the accumulated images but at every other timing, as a result of which it is possible to lighten the processing load upon the focus signal calculating circuit 12 and focus control circuit 13 that exercise AF control.

The example of FIG. 6 illustrates a case where charge accumulation and readout are performed four times in one vertical scanning period and AF control is carried out every other charge accumulation and readout of high-speed images. However, it goes without saying that it is possible to suitably modify the number of charge accumulations and readouts performed in one vertical scanning period and the number of times AF control is performed.

While the present invention has been described with reference to exemplary embodiments, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2005-262977, filed Sep. 9, 2005, which is hereby incorporated by reference herein in its entirety.

What is claimed is:

1. An image sensing apparatus comprising:
a processing unit that superimposes and synthesizes a plurality of images obtained by sensing with exposure period shorter than one vertical scanning period every vertical scanning period of a moving image while shifting them relative to one another so as to cancel out shaking of the image sensing apparatus, and outputting a single synthesized image every vertical scanning period;
a focus lens; and
a focus control unit that performs focus control by driving said focus lens based upon a sensed image in response to sensing of the plurality of images performed in each of the vertical scanning periods.

2. The apparatus according to claim 1, wherein said focus control unit performs focus control in accordance with sensing of two or more images among the plurality of images obtained every vertical scanning period.

3. The apparatus according to claim 2, wherein said focus control unit performs focus control whenever sensing of each of the plurality of images obtained every vertical scanning period is performed.

4. The apparatus according to claim 1, wherein said focus control unit performs focus control so as to heighten degree of sharpness based upon degree of sharpness of an image sensed anew and degree of sharpness of an image acquired immediately previously.

5. The apparatus according to claim 4, wherein said focus control unit performs focus control based upon the image sensed anew and degree of sharpness of an image sensed immediately previously.

6. A method of controlling an image sensing apparatus for sensing a plurality of images with exposure period shorter than one vertical scanning period every vertical scanning period of a moving image, said method comprising:
a processing step of superimposing and synthesizing the plurality of images while shifting them relative to one another so as to cancel out shaking of the image sensing apparatus, and outputting a single synthesized image every vertical scanning period;
a sensing step of sensing images at exposure times shorter than the one vertical scanning period; and
a focus control step of performing focus control based upon images obtained by sensing at said image sensing step.

7. The method according to claim 6, wherein focus control is performed at said focus control step in accordance with sensing of two or more images among the plurality of images obtained every vertical scanning period.

8. The method according to claim 7, wherein focus control is performed at said focus control step whenever sensing of each of the plurality of images obtained every vertical scanning period is performed.

9. The method according to claim 6, wherein focus control is performed at said focus control step so as to heighten degree of sharpness based upon degree of sharpness of an image sensed anew and degree of sharpness of an image acquired previously.

10. The method according to claim 9, wherein focus control is performed at said focus control step based upon the image sensed anew and degree of sharpness of an image sensed immediately previously.
